(19) United States
(12) Patent Application Publication
(10) Pub. No.: US 2008/0159228 A1
(43) Pub. Date: Jul. 3, 2008

(54) HANDOVER METHOD, MOBILE NODE AND ANCHOR POINT DEVICE

(75) Inventor: Tobias Kufner, Stutensee (DE)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 11/952,485

(22) Filed: Dec. 7, 2007

(30) Foreign Application Priority Data
Jan. 1, 2007 (EP) 07300716.3

(51) Int. Cl. H04Q 7/00

(52) U.S. Cl. 370/331

(57) ABSTRACT

The present invention relates to an improved fast hand over method for the mobile IPVv6. An anchor point device (20) sends information to a mobile node (10) comprising information of multiple candidate access routers. The mobile node sends a request for fast binding update to set candidate access routers (30, 40). The invention also relates to a mobile node (10) adapted to perform the handover method and to an anchor point device (20) adapted to perform the handover method.

The invention is based on a priority application EP 07 300 716.3 which is hereby incorporated by reference.

### TECHNICAL FIELD

The present invention relates to a handover method for mobile device communicating according to the mobile internet protocol version 6. The invention further relates to a mobile node adapted to perform the handover method and an anchor point device adapted to perform the handover method.

### BACKGROUND OF THE INVENTION

A mobility support for internet protocol version 6 (IPv6) has been proposed in IETF request for comments (RFC) 3775. For delay sensitive multimedia applications however the handover latency caused by mobile IPv6 can be too high. In the IETF request for comments (RFC) 4068 a fast handover method for mobile IPv6 has been proposed. The anticipated handover method proposed in RFC 4068 can solve the problem of handover latency if a certain handover prediction is available early enough. The mechanisms applied by the fast handover method described in RFC 4068 in order to reduce latency are sometimes referred to as handover preparation.

A hierarchical mobile IPv6 mobility management has been proposed in IETF RFC 4140. This document presents an extension to the mobile IPv6 presented in RFC 4068 to allow for local mobility handling. The RFC 4140 introduces a mobility anchor point to improve performance of a mobile IPv6 handover. RFC 4140 also presents examples of integrating the mobility anchor point (MAP) into the framework of fast handovers for mobile IPv6 of RFC 4068. One possibility is that the previous access router which is the anchor point device in the framework of RFC 4068 acts as the mobility anchor point. A second scenario discussed in RFC 4140 is to place the MAPs in an aggregation router above the access router.

In the handover method presented in RFC 4068 a mobile node receives a layer 2 trigger message, referred to in RFC 4068 as Proxy router Advertisement (PrRtAdv). The mobile node requests information on layer 3 of a new access router (NAR) from a previous access router (PAR) by using information included in the layer 2 trigger message. This is done by the mobile node sending a fast binding update (FBU) to the previous access router (PAR). The fast binding update is a request from the mobile node requesting the previous access router to perform fast binding update. The previous access router then sends a handover initiate message (HI) to the new access router (NAR). The new access router (NAR) sends a handover acknowledge message (HAck) to the previous access router (PAR).

In predictive fast handover the handover acknowledge message (HAck) is received by the previous access router (PAR) and the final handover decision is taken with the reception of the handover acknowledge message (HAck) at the previous access router (PAR). The mobile node then receives information on an IP address of the new access router (NAR) and the new care of address (NCoA) to be used when moving to the new access router (NAR) over the Fast Binding Acknowledgement (FBAck) message.

In reactive fast handover either no handover acknowledge message (HAck) is sent from the new access router (NAR) or the handover acknowledge message (HAck) is not received by the previous access router (PAR). In this case a fast neighbor advertisement message (FNA) is sent from the mobile node to the new access router (NAR) to announce attachment and to confirm the use of the new care of address (NCoA).

The United States Patent Application Publication US 2006 0029020 A1 a handover method is described and a new care of address is created using a media access control (MAC) address in the mobile IPv6.

The fast handover method of RFC 4068 has been designed to provide a better latency for e.g. multimedia applications. However fast handover is only successful if a certain handover prediction is available early enough. In future mobile networks especially in heterogeneous ones multiple candidate access routers can be available at the same time. The access points can be access routers of different access techniques. Due to unforeseeable radio link characteristics and terminal mobility, handover prediction is uncertain in these cases. Thus fast handover could be unreliable even if the new access router has been detected early enough.

The invention has the object of providing a method that enables reliable handover with low latency especially in a heterogeneous environment with different access routers of different access techniques. It is another object of the invention to provide a mobile node and an anchor point device performing that method.

### SUMMARY OF THE INVENTION

These objects and others that appear below are achieved by a handover method of the mobile IPv6 comprising the steps of: an anchor point device sending information to a mobile node, said information comprising an IP address of a first candidate access router and a first new care of address to be used for said mobile node when moving from said anchor point device to said first candidate access router, and an IP address of a second candidate access router and a second new care of address to be used for said mobile node when moving from said anchor point device to said second candidate access router, said anchor point device receiving a request from said mobile node, requesting the anchor point device to perform a fast binding update to said first and said second candidate access router, the handover method of the mobile IPv6 comprising the steps of: a mobile node receiving information from an anchor point device, said information comprising an IP address of a first candidate access router and a first new care of address to be used for said mobile node when moving from said anchor point device to said first candidate access router, and

an IP address of a second candidate access router and a second new care of address to be used for said mobile node when moving from said anchor point device to said second candidate access router, said mobile node sending a request to said anchor point device, requesting the anchor point device to perform a fast binding update to said first and said second candidate access router, a corresponding mobile node adapted to perform the handover method of claim 8 and an anchor point device adapted to perform the handover method of claim 1.

In future mobile networks, especially in heterogeneous ones, multiple candidate access routers can be available at the same time. Radio link characteristics and mobility of the mobile node in general are unforeseeable. Thus handover prediction in general is uncertain. In order to reduce handover latency for all available candidate access routers simultaneous handover preparations for two or more candidate access routers are proposed.

An anchor point device is for example an access router over which a mobile node is connected to an IP network. The mobile node is connected to the anchor point device over a wireless link e.g. a radio link. When the mobile node is moving a handover might become necessary when the mobile node is moving out of reach of the anchor point device.

According to one aspect of the invention the anchor point device sends information to a mobile node. The information comprises an IP address for a first candidate access router and a first new care of address to be used for that mobile node when moving from the anchor point device to the first candidate access router. The information also comprises an IP address of the second candidate access router and a second new care of address to be used for that mobile node when moving from the anchor point to that second candidate access router. This allows for simultaneous handover preparations. The anchor point device which can be a previous access router or a mobility anchor point provides information on multiple equivalent candidate access routers in this discovery phase. The anchor point device provides at least two but possibly more candidate access routers. The candidate access routers can provide comparable quality of service to the mobile node. The mobile node and the anchor point device then simultaneously prepare handover to each of that candidate access routers.

The mobile node receives the information sent from the anchor point device. The information comprises an IP address of a first candidate access router and a first new care of address to be used by the mobile node when moving from said anchor point device to said first candidate access router. The information also comprises the IP address of the second candidate access router and a second new care of address to be used for said mobile node when moving from said anchor point to said second candidate access router.

According to another aspect of the invention, the mobile node then sends a request to the anchor point device to requesting said anchor point device to perform a fast binding update to said first and that second candidate access router. Said anchor point device receives the request requesting to perform a fast binding update to that first and second candidate access routers.

According to another aspect of the invention the anchor point device prepares a handover of the mobile node having received a request for fast binding update. The anchor point device prepares a handover of the mobile node to that first and to that second candidate access router. The handover of the mobile node more than two, e.g. three, four or multiple, candidate access routers can also be prepared.

According to another aspect of the invention the preparation of handover may comprise that said anchor point device sends a first handover initiate message to said first candidate access router and a second handover initiate message to said second candidate access router. According to another embodiment of the invention handover initiate messages can be sent to more than two, e.g. three, four or multiple, candidate access routers.

Having sent the first and second handover initiate message the anchor point device may receive first and second handover acknowledge messages from said first and second candidate access routers respectively. If the anchor point device sends handover initiate messages to more than two candidate access routers more than two handover acknowledge messages may be received. Each candidate access router may send a handover acknowledge message to the anchor point device in response to the handover initiate message.

According to a preferred embodiment of the invention, the anchor point device performs a fast binding update by updating the binding cache with the mobile node's first and second new care of address. The fast binding update is performed for each of the candidate access routers, if multiple candidate access routers are present. In the case of multiple candidate access routers the binding cache is updated with the mobile node's first second, third and so on new care of address.

According to another aspect of the invention the anchor point device, after preparing the handover of the mobile node, makes a handover decision. The anchor point device decides to perform the handover to a new access router, the new access router being one of the first and second candidate access routers. The new access router can also be one of said more than two, e.g. three, four or multiple, candidate access routers. The handover may be performed by sending a fast binding acknowledgement to the mobile node from the anchor point device. The fast binding acknowledgement indicates the new access router, the new access router being the one of the candidate access routers to which the handover is to be performed.

According to another embodiment of the invention, there is a anchor point device which is a mobility anchor point and which does not correspond to the previous access router. According to this embodiment, the fast binding update may be sent from the mobile node to the mobility anchor point. The mobility anchor point may send in return the fast binding acknowledgement to the mobile node. The mobile node then receives the fast binding acknowledgement from the mobility anchor point.

According to another embodiment of the invention the mobile node requests information of candidate access routers from said anchor point device prior to receiving information from said anchor point device. Said information comprises the IP address and the new care of address from first and second candidate access routers. This request may be triggered by a layer 2 trigger received by the mobile node.

According to another embodiment of the invention the mobile node receives a fast neighbour advertisement message from the new access router over the new link by which the mobile is connect to a new access router.

As soon as the handover to the new access router has been completed redundant handover preparations are stopped.

### BRIEF DESCRIPTION OF THE DRAWINGS

Other characteristics and advantages of the invention will become apparent in the following detailed description of preferred embodiments of the invention illustrated by the accompanying drawing given by way of non limiting illustration.

FIG. 1 shows a schematic overview of an example of an inventive handover method.

### DETAILED DESCRIPTION OF PREFERRED EMBODIMENTS

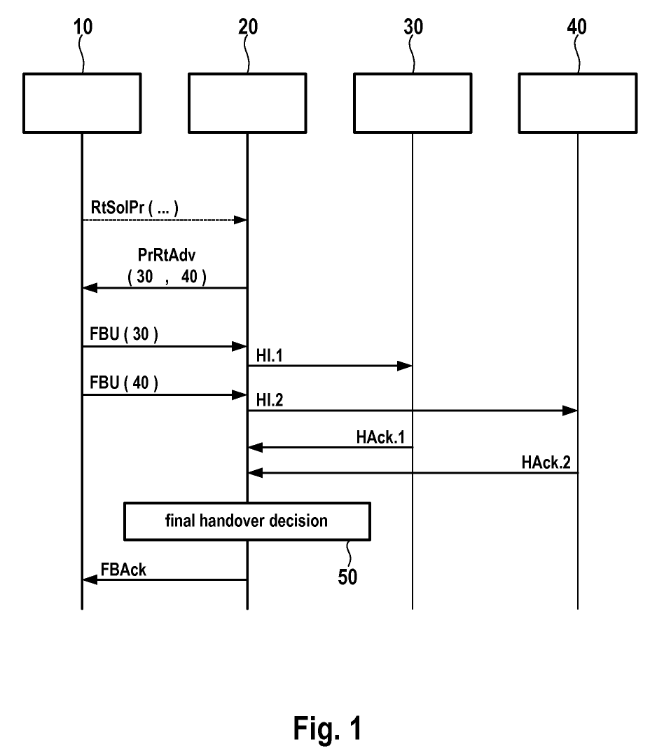

FIG. 1 shows the schematic overview of an example of an inventive handover method. The handover method provides simultaneous handover preparations for fast handover for mobile IPv6. It applies to network controlled handover methods. At the beginning of the method the mobile node 10 optionally sends the router solicitation for proxy advertisement message RtSoIPr to the anchor point device 20. The router solicitation for proxy advertisement message RtSoIPr requests information of candidate access routers 30, 40 from the anchor point device 20. Candidate access routers 30,40 are routers to which the mobile node 10 can be potentially handed over.

Sending out this message enables the mobile node 10 to discover candidate access routers 30, 40 providing access to an IP network.

The anchor point device 20 then sends a proxy router advertisement PrRtAdv message to the mobile node 10 that provides information about neighbouring links provided by candidate access routers 30, 40. In case a network initiated handover is performed the proxy router advertisement message PrRtAdv acts as an initiating trigger.

If multiple equivalent candidate access routers 30, 40 are available the anchor point device 20 provides information about each of these candidate access routers 30, 40. This information can be provided in an unsolicited PrRtAdv message or in a PrRtAdv message that is emitted in response to a RtSoIPr message.

The proxy router advertisement message PrRtAdv comprises an IP address of each of the candidate access routers 30, 40 and new care of address information NCoA to be used for the mobile node 10 when moving from the anchor point 20 to one of the candidate access routers 30, 40.

In the example shown in FIG. 1 the anchor point device 20 sends information in the PrRtAdv message about candidate access routers 30 and 40. The mobile node 10 receives the proxy router advertisement PrRtAdv information comprising information about each of the candidate access routers 30, 40. In response the mobile node 10 sends a fast binding update request FBU requesting fast binding update for each of these candidate access routers 30, 40. The fast binding update request FBU may comprise several fast binding update requests FBU(30), FBU(40) one for each candidate access router 30, 40. In the example shown in FIG. 1 one fast binding update request FBU (30) is sent for candidate access router 30 and one fast binding update request FBU (40) is sent for candidate access router 40.

The anchor point device 20 performs network side preparations for handover to each of the candidate access routers 30, 40. The handover preparations comprise handover initiate messages HI.1, HI.2 to each of the candidate access routers 30, 40 and receiving handover acknowledge messages HAck.1, HAck.2 from each of the candidate access routers 30, 40. In the example shown in FIG. 1 the first candidate access router 30 receives the first handover initiated message HI.1 and sends the first handover acknowledge message HAck.1. The second candidate access router 40 receives the second handover initiated message HI.2 and sends the second handover acknowledge message HAck.2.

The handover preparations shown in FIG. 1 are for two candidate access routers 30, 40. The preparations may be performed for more than two candidate access routers.

At one point 50 of the process shown in FIG. 1 final handover decision is taken by the anchor point device 20.

In predictive fast handover the anchor point device 20 sends a fast binding acknowledge message FBAck to the mobile node 10, said fast binding acknowledge message FBAck comprising information about the new access router. The new access router is the access router to which the handover is to be performed. When performing predictive fast handover the fast binding acknowledgement message is sent from the anchor point device 20 to the mobile node 10 after receiving handover acknowledge messages HI.1, HI.2 from at least one of the candidate access routers 30, 40. In another embodiment of the invention the final handover decision 50 is taken after having received all handover acknowledge HI.1, HI.2 messages of all candidate access router 30, 40.

In reactive fast handover the handover is performed without the mobile node 10 having received a fast binding acknowledgment message FBAck from the anchor point device 20. In this case the mobile node 10 sends out a fast neighbour advertisement message FNA on the new link to the new access router. The fast neighbour advertisement message announces the new access router used by the mobile node 10.

As soon as the fast handover is completed all redundant handover preparations can be stopped.

1. A handover method of the mobile IPv6 comprising the steps of:
a) an anchor point device sending information to a mobile node, said information comprising
an IP address of a first candidate access router and a first new care of address to be used for said mobile node when moving from said anchor point device to said first candidate access router, and
an IP address of a second candidate access router and a second new care of address to be used for said mobile node when moving from said anchor point device to said second candidate access router,
b) said anchor point device receiving a request from said mobile node, requesting the anchor point device to perform a fast binding update to said first and said second candidate access router.

2. The handover method according to claim 1, further comprising the steps of
c) said anchor point device preparing a handover of said mobile node to said first candidate access router and to said second candidate access router.

3. The handover method according to claim 2, step c) comprising the step of
said anchor point device sending a first handover initiate message to said first candidate access router and a second handover initiate message to said second candidate access router.

4. The handover method according to claim 3, step c) further comprising the step of
said anchor point device receiving a first handover acknowledge message from said first candidate access router and a second handover acknowledge message from said second candidate access router.

5. The handover method according to claim 4, further comprising the step of
said anchor point device performing said fast binding update by updating the binding cache with the mobile node's first and second new care of address.

6. The handover method according to claim 1, further comprising the step of
said anchor point device making a handover decision, deciding to perform the handover to a new access router, the new access router being one of the first and second candidate access routers.

7. The handover method according to claim 6, further comprising the step of
said anchor point device sending a fast binding acknowledgement to said mobile node, indicating the new access router.

8. The handover method of the mobile IPv6 comprising the steps of:
i) a mobile node receiving information from an anchor point device, said information comprising
an IP address of a first candidate access router and a first new care of address to be used for said mobile node when moving from said anchor point device to said first candidate access router, and
an IP address of a second candidate access router and a second new care of address to be used for said mobile node when moving from said anchor point device to said second candidate access router,
ii) said mobile node sending a request to said anchor point device, requesting the anchor point device to perform a fast binding update to said first and said second candidate access router.

9. The handover method according to claim 8, further comprising the step of
said mobile node prior to step i) requesting information of candidate access routers from said anchor point device.

10. The handover method according to claim 8, further comprising the step of
said mobile node receiving from said anchor point device a fast binding acknowledgement, indicating the new access router, the new access router being the one of the first and second candidate access routers, to which the handover is to be performed.

11. The handover method according to claim 8, further comprising the step of
receiving a fast neighbor advertisement message from a new access router, the new access router being the one of the first and second candidate access routers to which the handover has been performed.

12. A mobile node adapted to perform the handover method of claim 8.

13. An anchor point device adapted to perform the handover method of claim 1.

14. The anchor point device according to claim 13, whereby the anchor point device being a previous access router.

15. The anchor point device according to claim 13, whereby the anchor point device being a mobility anchor point.
